(19) United States
(12) Patent Application Publication
(10) Pub. No.: US 2025/0216735 A1
(43) Pub. Date: Jul. 3, 2025

(54) LIQUID CRYSTAL DISPLAY DEVICE

(71) Applicant: Shanghai Tianma Micro-Electronics Co., Ltd., Shanghai (CN)

(72) Inventor: Akira TANABE, Kawasaki (JP)

(73) Assignee: Shanghai Tianma Micro-Electronics Co., Ltd., Shanghai (CN)

(21) Appl. No.: 18/965,028

(22) Filed: Dec. 2, 2024

(30) Foreign Application Priority Data
Dec. 28, 2023 (JP) 2023-222615
Sep. 24, 2024 (JP) 2024-165017

(51) Int. Cl. G02F 1/137; G02F 1/1333; G02F 1/13357

(52) U.S. Cl. CPC G02F 1/137; G02F 1/133368; G02F 1/133602

(57) ABSTRACT

A liquid crystal display device includes a liquid crystal display panel in which a liquid crystal layer is disposed, a back light that illuminates the liquid crystal display panel from behind and that includes an imaging region in which an imager is provided, and a controller that controls a luminance of the liquid crystal display panel. The liquid crystal display panel includes a display region, and a dimming region provided so as to, when viewing the liquid display panel planarly, overlap with the imaging region of the back light. A dimming filter is provided in the dimming region. The controller is configured to control driving of the liquid crystal layer in the dimming region such that a luminance when the display region is set to zero tone and a luminance of the dimming region match.

### CROSS-REFERENCE TO RELATED APPLICATIONS

This application claims the benefit of Japanese Patent Application No. 2023-222615, filed on Dec. 28, 2023, and Japanese Patent Application No. 2024-165017, filed on Sep. 24, 2024, of which the entirety of the disclosures is incorporated by reference herein.

### FIELD OF THE INVENTION

This application relates generally to a liquid crystal display device.

### BACKGROUND OF THE INVENTION

Display devices provided with a configuration in which an imaging device is disposed behind a display (Camera Under Display: CUD) are actively being developed.

For example, Unexamined Japanese Patent Application Publication No. 2021-117362 indicates that, when applying CUD technology to a liquid crystal display device, disposing a camera and an infrared (IR) light source in a portion where a structural member (light guide plate, optical sheet, or the like of the back light) of a region where the camera and the light source are to be disposed is hollowed out.

The liquid crystal panel corresponding to the region in which the camera and the IR light source are disposed is provided with a blind region (light shield) for hiding the camera and the IR light source so that the user cannot visually recognize the camera and the IR light source. Typically, the light shield is formed on a cover glass adhered to the liquid crystal panel by using an IR ink that blocks visible light and transmits only IR light.

However, when using conventional IR ink, a luminance difference occurs between the blind region and the display region when causing the display region to display black (zero gradation) or a low gradation, which leads to the problem of the user being able to clearly visually recognize the blind region.

### SUMMARY OF THE INVENTION

A liquid crystal display device according to a first embodiment of the present disclosure includes:

a liquid crystal display in which a liquid crystal layer is disposed;

an illuminator that illuminates the liquid crystal display from behind and that includes an imaging region in which an imager is provided; and

a controller that controls a luminance of the liquid crystal display, wherein

the liquid crystal display includes a display region, and a dimming region provided so as to, when viewing the liquid crystal display planarly, overlap with the imaging region of the illuminator, a dimming filter being provided in the dimming region, and

the controller is configured to control driving of the liquid crystal layer in the dimming region such that a luminance when the display region is set to zero tone and a luminance of the dimming region match.

It is to be understood that both the foregoing general description and the following detailed description are exemplary and explanatory and are not restrictive of this disclosure.

### BRIEF DESCRIPTION OF DRAWINGS

A more complete understanding of this application can be obtained when the following detailed description is considered in conjunction with the following drawings, in which:

FIG. 1 is a drawing schematically illustrating a liquid crystal display device according to Embodiment 1;

FIG. 2 is a cross-sectional view taken along line II-II illustrated in FIG. 1;

FIG. 3 is a partial plan view of a liquid crystal display panel;

FIG. 4 is a cross-sectional view taken along line IV-IV illustrated in FIG. 3;

FIG. 5 is a partial cross-sectional view of a liquid crystal display panel according to Embodiment 2;

FIG. 6 is a partial cross-sectional view of a liquid crystal display panel according to Embodiment 3;

FIG. 7 is a partial cross-sectional view of a liquid crystal display panel according to Embodiment 4;

FIG. 8 is a partial cross-sectional view of a liquid crystal display panel according to Embodiment 5;

FIG. 9 is a plan view for explaining the arrangement of a dimming filter in the liquid crystal display panel according to Embodiment 5;

FIG. 10 is a plan view for explaining the arrangement of the dimming filter in the liquid crystal display panel according to Embodiment 5;

FIG. 11 is a drawing for explaining a modified example of Embodiment 5;

FIG. 12A is a drawing for explaining a first step of a manufacturing process of the dimming filter of the modified example of Embodiment 5;

FIG. 12B is a drawing for explaining a second step of the manufacturing process of the dimming filter of the modified example of Embodiment 5;

FIG. 12C is a drawing for explaining a third step of the manufacturing process of the dimming filter of the modified example of Embodiment 5;

FIG. 12D is a drawing for explaining a fourth step of the manufacturing process of the dimming filter of the modified example of Embodiment 5;

FIG. 13A is a drawing for explaining a first step of another manufacturing process of the dimming filter of the modified example of Embodiment 5;

FIG. 13B is a drawing for explaining a second step of the other manufacturing process of the dimming filter of the modified example of Embodiment 5;

FIG. 13C is a drawing for explaining a third step of the other manufacturing process of the dimming filter of the modified example of Embodiment 5;

FIG. 14 is a partial cross-sectional view of a liquid crystal display panel according to Embodiment 6;

FIG. 15 is a drawing for explaining the configuration of a controller according to

Embodiment 7;

FIG. 16A is a top view of a back light;

FIG. 16B illustrates a luminance distribution of the back light along line B-B of FIG. 16A;

FIG. 16C is a drawing illustrating the transmittance of a liquid crystal layer at a position corresponding to the line B-B of FIG. 16A;

FIG. 16D is a drawing illustrating the transmittance of a color filter of a display region and a dimming filter of a dimming region, at the position corresponding to the ling B-B of FIG. 16A;

FIG. 16E is a drawing illustrating the luminance of the liquid crystal display device at the position corresponding to the line B-B of FIG. 16A; and

FIG. 17 is a drawing for explaining a modified example.

### DETAILED DESCRIPTION OF THE INVENTION

In the following, a liquid crystal display device according to various embodiments is described while referencing the drawings.

### Embodiment 1

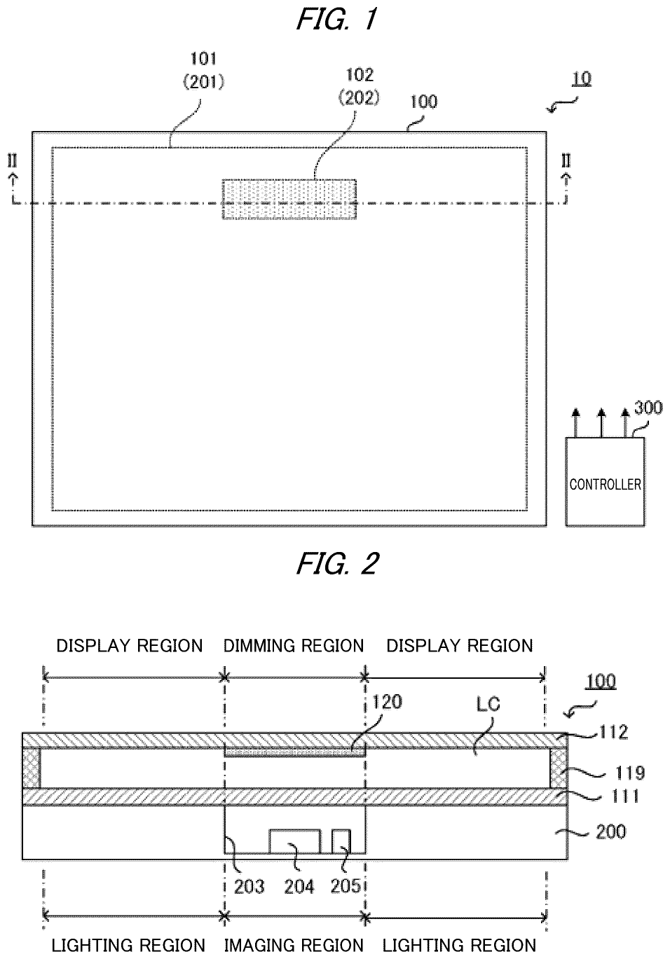

As illustrated in FIGS. 1 and 2, a liquid crystal display device 10 according to the present embodiment includes a liquid crystal display panel 100, a back light 200, and a controller 300. In the present embodiment, the liquid crystal display device 10 has a CUD structure in which an imaging device is disposed behind the liquid crystal display panel 100. In one example, the liquid crystal display device 10 is used as a vehicle-mounted display device.

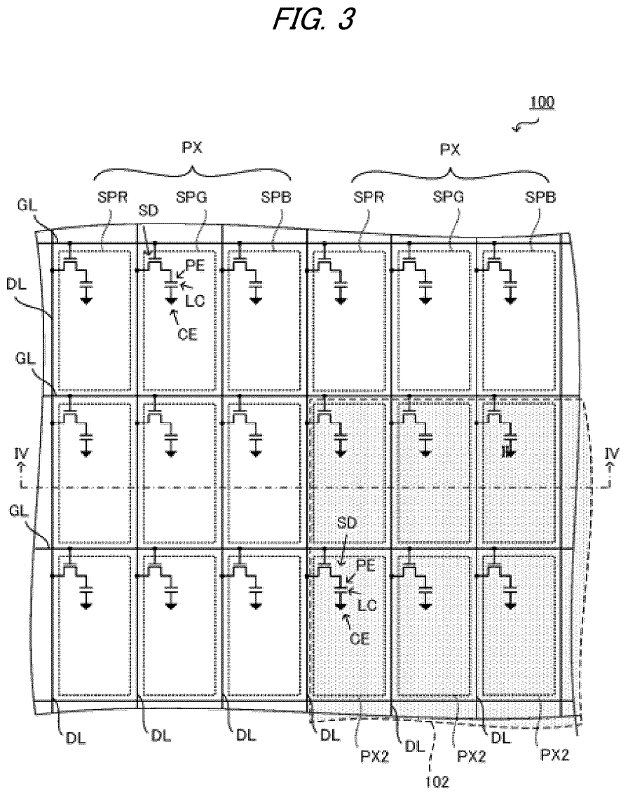

In one example, the liquid crystal display panel 100 is implemented as a horizontal electric field type color liquid crystal display panel that is active matrix driven by thin film transistors (TFT). Note that a configuration is possible in which the liquid crystal display panel 100 is implemented as a vertical alignment (VA) type, a twisted nematic (TN) type, or similar vertical electric field type color liquid crystal display panel. The liquid crystal display panel 100 displays characters and/or images. As illustrated in FIG. 1, the liquid crystal display panel 100 includes a display region 101, and a dimming region 102 provided in the display region 101. As illustrated in FIG. 3, pixels PX and PX2 are arranged in a matrix in the display region 101. The dimming region 102 is a region (blind region) for blinding such that an imaging region 202 provided on the back light 200 is not visually recognized by a user. As such, as illustrated in FIGS. 1 and 2, when viewing the liquid crystal display device 10 planarly (when viewed from the user), the dimming region 102 is provided so as to overlap with the imaging region 202 of the back light 200, and a lighting region 201 of the back light 200 is provided so as to overlap with the display region 101. The dimming region 102 transmits IR light and visible light. The display region 101 is a region that is capable of displaying characters, images, and the like, and the dimming region 102 is a region that does not display characters, images, and the like. Note that, to facilitate comprehension, for the liquid crystal display panel 100, only an active matrix substrate 111, a liquid crystal layer LC, a counter substrate 112, a seal material 119, and a dimming filter 120 are illustrated in FIG. 2.

As illustrated in FIG. 2, the back light (illuminator) 200 is arranged on the back surface side of the liquid crystal display panel 100. The back light 200 is implemented as an edge-lit back light, and includes a white light emitting diode (LED) element, a reflective sheet, a light guide plate, a diffusion sheet, a lens sheet, and a polarizing sheet (all not illustrated in the drawings). Additionally, a recess 203 is formed in the back light 200 by hollowing out the light guide plate, the diffusion sheet, and other optical sheets. An imaging device 204 and an IR light source 205 are provided in the recess 203. The recess 203 in which the imaging device 204 and the IR light source 205 are provided is called an “imaging region 202.” Although the light guide plate and the like are not positioned in the imaging region 202, light from the lighting region 201 surrounding the imaging region 202 leaks into the imaging region 202. As such, the in-plane luminance of the imaging region 202 (for example, 500 cd/m²) is low compared to that of the lighting region 201 (for example, 12000 cd/m²). Accordingly, light of lower luminance compared to that of the display region 101 enters the dimming region 102 that overlaps the imaging region 202.

The controller 300 includes a central processing unit (CPU), a memory, a power supply circuit, and the like, and controls the liquid crystal display panel 100 and the back light 200. In one example, the CPU executes programs stored in the memory to realize the controller 300. Specifically, the controller 300 controls a gate driver and a data driver, supplies a video signal (gradation voltage) to a driver IC of the liquid crystal display panel 100, displays characters and/or images in the display region 101, and drives liquid crystal cells in the dimming region 102. Additionally, the controller 300 sends a current value signal, expressing a current value to be applied to the light source, to the lighting circuit of the back light 200.

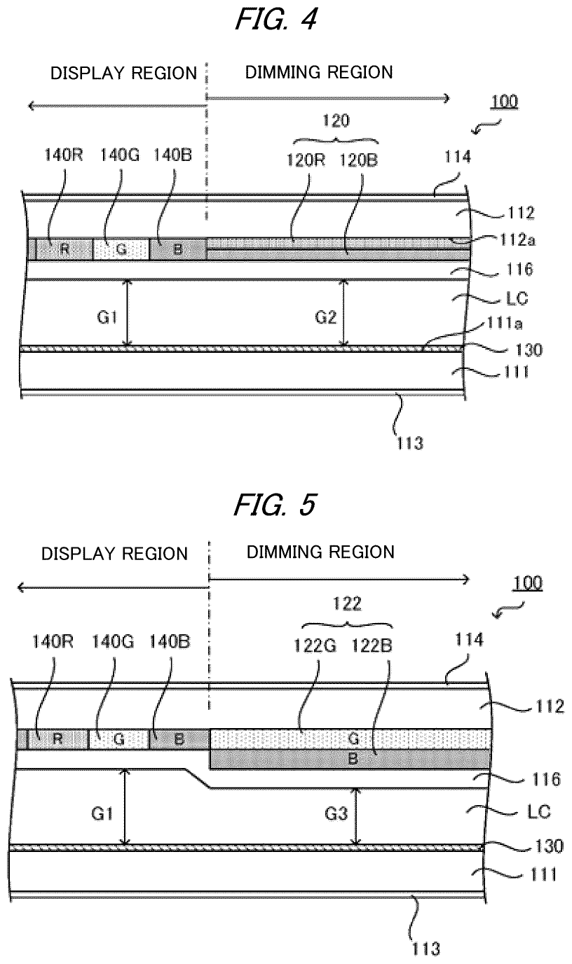

As illustrated in FIGS. 2 and 4, the liquid crystal display panel 100 includes an active matrix substrate 111, a counter substrate 112, and a liquid crystal layer LC. The counter substrate 112 is adhered to the active matrix substrate 111 by a seal material 119. Additionally, the liquid crystal display panel 100 includes a polarizing plate 113 provided on a lower surface of the active matrix substrate 111, and a polarizing plate 114 provided on an upper surface of the counter substrate 112. In the present embodiment, the liquid crystal display panel 100 is implemented as a transmissive liquid crystal display panel. In one example, the liquid crystal display panel 100 operates in a known transverse electric field mode or vertical electric field mode.

In one example, the counter substrate 112 is implemented as a glass substrate. As illustrated in FIG. 4, color filters 140R, 140G, and 140B, a dimming filter 120, an overcoat film 116, and an alignment film (not illustrated in the drawings) are provided on a main surface 112a of the counter substrate 112 opposing the active matrix substrate 111.

In one example, the active matrix substrate 111 is implemented as a glass substrate. As illustrated in FIG. 3, a plurality of gate lines GL, a plurality of data lines DL, a switching element SD, a pixel electrode PE, a common electrode CE, an alignment film (not illustrated in the drawings) for aligning the liquid crystal layer LC, and the like are provided on a main surface 111a of the active matrix substrate 111 opposing the counter substrate 112. When the liquid crystal display panel 100 operates in the vertical electric field mode, the common electrode CE is provided on the counter substrate 112. Note that, in FIG. 4, to facilitate comprehension, the switching element SD, the pixel electrode PE, and the like are illustrated collectively as an electrode forming layer 130.

As illustrated in FIG. 3, the gate lines GL of the active matrix substrate 111 extend in the horizontal direction and are arranged juxtaposed in the vertical direction. The data lines DL of the active matrix substrate 111 extend in the vertical direction and are arranged juxtaposed in the horizontal direction. The gate lines GL and the data lines DL surround one set of the pixel electrode PE, the common electrode CE, and the switching element SD that forms a pixel PX. The gate lines GL and the data lines DL are formed from a metal such as aluminum (Al), molybdenum (Mo), or the like. The gate lines GL and the data lines DL correspond to pixel lines.

The pixel electrode PE is arranged in a matrix. In one example, the pixel electrode PE is formed from indium tin oxide (ITO). The pixel electrode PE is formed in a comb teeth shape. The common electrode CE is formed in a comb teeth shape from ITO. The comb teeth of the pixel electrode PE and the comb teeth of the common electrode CE are arranged alternately, parallel to each other. Due to this, a transverse electric field parallel to the main surface 111a of the active matrix substrate 111 is generated between the comb teeth of the pixel electrode PE and the comb teeth of the common electrode CE. Meanwhile, when operating in the vertical electric field mode, the pixel electrode PE and the common electrode CE are not formed in comb teeth shapes and are disposed facing each other across the liquid crystal layer. Due to this, a vertical electric field perpendicular to counter substrate 112 and the main surface 111a of the active matrix substrate 111 is generated between the pixel electrode PE and the common electrode CE.

In one example, the switching element SD is implemented as a TFT element. The switching element SD is provided near the intersections of the gate lines GL and the data lines DL. The switching element SD includes a gate electrode, a source electrode, a drain electrode, and a semiconductor layer (all not illustrated in the drawings). The gate electrode of the switching element SD connects to a gate line GL, and the source electrode of the switching element SD connects to a data line DL. The drain electrode of the switching element SD connects to the pixel electrode PE. The gate electrode, the source electrode, and the drain electrode are formed from a metal such as aluminum, molybdenum, or the like. The semiconductor layer of the switching element SD is formed from amorphous silicon, an oxide including indium (In), gallium (Ga), and zinc (Zn), or the like.

The switching element SD is sequentially driven on the basis of scan signals supplied from the gate driver via the gate line GL that connects to the gate electrode. When the switching element SD is in an open state, a video signal (gradation voltage) supplied from the data driver is supplied to the drain electrode via the data line DL that connects to the source electrode. Moreover, a predetermined transverse electric field parallel to the main surface 111a of the active matrix substrate 111 is generated between the comb teeth of the pixel electrode PE connected to the drain electrode and the comb teeth of the common electrode CE, and the predetermined transverse electric field is applied to the liquid crystal. Note that the common electrode CE is connected to a common line, and the potential of the common electrode CE is controlled to a predetermined potential. Meanwhile, when operating in the vertical electric field mode, a predetermined vertical electric field perpendicular to the common electrode CE and the main surface 111a of the active matrix substrate 111 is generated between the common electrode CE and the pixel electrode PE connected to the drain electrode, and the predetermined vertical electric field is applied to the liquid crystal.

As illustrated in FIG. 3, a plurality of pixels PX is arranged in a matrix in the display region 101 of the liquid crystal display panel 100. Each pixel PX includes a red (R) subpixel SPR, a green (G) subpixel SPG, and a blue (B) subpixel SPB. The subpixel SPR, the subpixel SPG, and the subpixel SPB are repeatedly arranged in this order. In the present embodiment, the liquid crystal display panel 100 also includes, in the dimming region 102, at least one pixel PX2 similar to the subpixels SPR, SPG, and SPB of the display region 101. The pixel PX2 of the dimming region 102 includes a pixel electrode and a common electrode similar to the subpixels SPR, SPG, and SPB. The number of the pixel PX2 provided in the dimming region 102 may be determined as desired. For example, m×n (where m and n are natural numbers) of the pixel PX2 can be provided.

As illustrated in FIG. 3, in the present embodiment, as with the pixel PX of the display region, a switching element SD, a pixel electrode PE, a common electrode CE, and the like are provided in the pixel PX2 of the dimming region 102. Moreover, the pixel PX2 in the dimming region 102 can control the liquid crystal layer LC and adjust the transmittance of the liquid crystal layer LC.

In FIG. 3, the pixels PX and the pixels PX2 arranged in one pixel row are connected to a common gate line GL. Additionally, the pixels PX2 arranged in the same subpixel column as the subpixel SPR are connected to a common data line DL. The same applies for the subpixel columns that are the same as the subpixels SPG and SPB. When the pixel PX2 is not disposed in the dimming region and not driven, the number of pixels PX connected to the data lines and the gate lines passing through the dimming region decreases. As such, the load capacity from the perspective of the output of the gate driver and the data driver changes, and a delay state of the scan signals and the data signals transmitted through the various lines changes. There is a high possibility that these changes will lead to the deterioration of display quality, such as the occurrence of luminance inconsistencies. The present embodiment illustrated in FIG. 3 is a preferable embodiment from the perspective of preventing the deterioration of display quality.

The dimming filter 120 provided in the dimming region 102 is a filter for attenuating the light that enters from the back light 200. The dimming filter 120 is provided in the entirety of the dimming region 102. The dimming filter 120 transmits visible light and infrared light, including near infrared light. An optical density (OD) value of the dimming region 102 in which the dimming filter 120 is provided is from 1.49 to 3.10 (transmittance: 0.08% to 3.2%). As illustrated in FIG. 4, the dimming filter 120 is formed by stacking two subfilters 120R and 120B.

In the present embodiment, an example of a configuration is described in which red and blue color filters are used. The subfilters are formed from the same material as color filters that are typically used in liquid crystal display devices. Two colors of color filters are selected as desired from the red, green, and blue color filters used in liquid crystal display devices.

The black matrix (BM) typically used in liquid crystal display devices does not transmit light in the near infrared region. In contrast, the transmittance of the near infrared region of each of the red, green, and blue colors used by the color filters is high (>90%). As such, by forming the dimming filter 120 using the color filter resist used in liquid crystal display devices, the dimming filter 120 can dim light in the visible light region (380 to 780 nm) and transmit light in the infrared region, particularly the near infrared region (800 to 2500 nm). It is preferable that the dimming filter 120 can transmit light having the wavelength of the IR light source such as, for example, light having a wavelength of 940 nm.

Note that the combination of the colors of the subfilters used as the dimming filter 120 can be determined as desired. For example, a red subfilter and a green subfilter, or a green subfilter and a blue subfilter may be stacked. Furthermore, subfilters of the three colors, namely red, green, and blue, may be stacked. Here, when the user observes the liquid crystal display panel 100, the color of the subfilter positioned closest to the user, that is, the subfilter provided directly on the counter substrate 112, is visually recognized by the user. As such, it is preferable that the order in which the subfilters are stacked is selected in accordance with the use of the liquid crystal display device 10.

The subfilters 120R, 120B of the dimming filter 120 may each be formed from the same material as the color filters used in the display region 101, or may be formed from a different material. Since the same material can be used, it is preferable that the same material is used. Note that, in the present embodiment, the thickness of the red subfilter 120R and the blue subfilter 120B is less than that of the color filters of the display region 101 and, as such, the red subfilter 120R and the blue subfilter 120B must be formed and patterned using a processes separate from the color filters of the display region 101. Regarding this, as another method for forming color filters having different resist thicknesses for the display region 101 and the dimming region 102, the color filters of the dimming filter 120 and the display region 101 can be formed using the same process by using a multi-gradation mask that allows exposure at multiple levels of light intensity. Color filters having different thicknesses after development can be formed by using the multi-gradation mask to expose the color filter resists to a medium intensity of light.

In the present embodiment, the thickness of the dimming filter 120 is formed to the same thickness as the color filters of the pixels provided in the display region 101. Due to this, the cell gap G1 in the display region 101 and the cell gap G2 in the dimming region 102 can be made the same. It is preferable that the cell gap G1 and the cell gap G2 are the same because, in such a case, the liquid crystal layer LC in the pixel PX2 in the dimming region 102 can be controlled in the same manner as the control of the liquid crystal layer LC in the pixel PX.

When the dimming filter 120 is obtained by stacking two layers of the subfilters 120R and 120B, the thickness of each of the subfilters 120R and 120B is set to half the thickness of the color filters of the display region 101, and the thickness when the two layers are stacked is the same as that of one of the color filters. Note that, provided that the attenuation rate required of the dimming filter 120 can be achieved, the thickness of each of the subfilters 120R and 120B may be set as desired. For example, provided that the thickness of the dimming filter 120 is the same as the thickness of the color filters of the display region 101, the thicknesses of the subfilters 120R and 120B may differ from each other.

The light that enters the dimming region 102 from the back surface of the liquid crystal display panel 100 is attenuated at each of the polarizing plate, the electrode forming layer, the liquid crystal layer, the color filter, and the polarizing plate. In the present embodiment, an OD value and the like of the dimming region 102 is adjusted so that the calculated luminance when driving the pixel PX2 of the dimming region 102 exceeds the black luminance of the display region 101. Due to this, it is possible to easily lower the transmittance of the liquid crystal layer LC by reducing the driving voltage of the pixel PX2 and, as such, the luminance of the dimming region 102 can be matched to the black luminance of the display region 101. In one example, an example is described in which a measured value of the black luminance of the display region 101 is 0.5 cd/m² and a measured value of the light that enters the dimming region 102 is 500 cd/m². In this case, the dimming region 102 is configured such that the calculated luminance when the pixel PX2 of the dimming region 102 is driven exceeds 0.5 cd/m². Then, the driving voltage is adjusted such that the luminance of the dimming region 102 becomes 0.5 cd/m² by reducing the voltage applied to the pixel PX2. Note that, in the present specification, the term “match” allows for error, and includes cases in which the luminance difference is within ±10%.

In the present embodiment, the subpixels SP of the display region 101 and the pixels of the dimming region 102 have the same configuration, except for the color filter. Accordingly, for the common constituents, the attenuation rate is the same and, as such, there is a benefit in that it is easier to simulate the attenuation rate in the dimming region 102.

Thus, in the present embodiment, the dimming filter 120 is provided in the dimming region 102 and, furthermore, the liquid crystal layer LC in the dimming region 102 is driven and controlled so as to transmit the light from the back light 200. As a result, the luminances of the dimming region 102 and the display region 101 are matched. Thus, according to the liquid crystal display device 10 of the present embodiment, it is possible to prevent the user from visually recognizing the dimming region 102.

### Embodiment 2

In the following, a liquid crystal display device 10 according to Embodiment 2 is described. The present embodiment differs from Embodiment 1 described above in that a cell gap G3 of the dimming region 102 is smaller than the cell gap G1 of the display region 101. The features common with Embodiment 1 are denoted with the same reference numerals, and detailed descriptions thereof are forgone.

As illustrated in FIG. 5, a dimming filter 122 of the present embodiment is also formed by stacking a green subfilter 122G and a blue subfilter 122B. In the present embodiment, as illustrated in FIG. 5, the dimming filter 122 is formed thicker than the color filters of the display region 101. Forming the dimming filter 122 thicker compared to in Embodiment 1 is preferable because doing so makes it possible to increase the attenuation rate of the dimming filter 122. Here, the cell gap G3 is a gap into which the liquid crystal layer LC can be introduced. When using the same driving voltage as the pixel PX of the display region 101, the electric field applied to the liquid crystal layer LC can be strengthened in narrower cell gap, and the response time can be improved.

Note that, in the present embodiment as well, the combination of the colors of the subfilters can be determined as desired. Furthermore, the number of subfilters is not limited to two, and may be three. In particular, it is preferable that subfilters of three colors, namely red, green, and blue are stacked because doing so results in the reduction in the color difference with the black of the display region 101.

When the subfilters have the same thickness as the color filters of the display region 101 and are formed from the same material as the color filters of the display region 101, there is a benefit in that manufacturing is facilitated due to being able to form the subfilters of the dimming filter 122 using the process used to manufacture the color filters of the display region 101.

In the present embodiment as well, the dimming filter 122 is provided in the dimming region 102 and, furthermore, the liquid crystal layer LC in the dimming region 102 is driven and controlled so as to transmit the light from the back light 200. In particular, in the present embodiment, the dimming filter 122 is forming thick and, as such, the attenuation rate of the dimming filter 122 can be increased. Due to this, it is possible to prevent the user from visually recognizing the dimming region 102.

### Embodiment 3

In the following, a liquid crystal display device according to Embodiment 3 is described. The present embodiment differs from Embodiments 1 and 2 described above in that a recess 112b is provided on the main surface 112a of the counter substrate 112, and a dimming filter 123 is provided partially in this recess 112b. The features common with the embodiments described above are denoted with the same reference numerals, and detailed descriptions thereof are forgone.

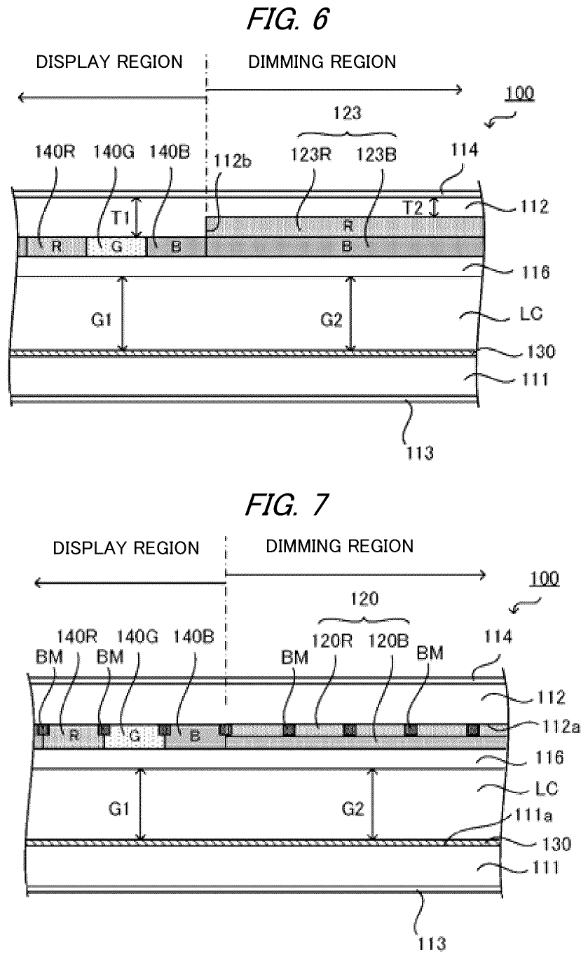

As illustrated in FIG. 6, a dimming filter 123 of the present embodiment is formed by stacking subfilters 123R and 123B. In the present embodiment, the dimming filter 123 is formed thicker than color filters 140R, 140G, and 140B of the display region 101. In the present embodiment, a recess 112b is provided on a surface of the counter substrate 112 opposing the active matrix substrate 111. Accordingly, a thickness T1 of the counter substrate 112 in the display region 101 is greater than a thickness T2 in the dimming region 102 (T1>T2).

The dimming filter 123 is provided in the recess 112b of the counter substrate 112. Due to this, there are benefits in that the dimming filter 123 can be formed thicker and the attenuation rate of the dimming filter 123 can be easily increased. In addition, as illustrated in FIG. 6, the cell gap G2 of the dimming region 102 can be made the same as the cell gap G1 of the display region 101. Due to this, the liquid crystal layer LC in the pixel PX2 in the dimming region 102 can be controlled in the same manner as the control of the liquid crystal layer LC in the pixel PX.

Note that, in the present embodiment as well, the combination of the colors of the subfilters can be determined as desired. Furthermore, the number of subfilters is not limited to two, and may be three. In particular, it is preferable that subfilters of three colors, namely red, green, and blue are stacked because doing so results in the reduction in the color difference with the black of the display region 101.

When the subfilters have the same thickness as the color filters of the display region 101 and are formed from the same material and have the same stacking order, there is also a benefit in that manufacturing is facilitated due to being able to form the subfilters of the dimming filter 123 using the process used to manufacture the color filters of the display region 101.

### Embodiment 4

In the following, a liquid crystal display device according to Embodiment 4 is described. The present embodiment differs from Embodiment 1 described above in that the subpixels SPR, SPG, and SPB of the display region 101 are defined by the black matrix BM. The features common with the embodiments described above are denoted with the same reference numerals, and detailed descriptions thereof are forgone.

As illustrated in FIG. 7, the subpixels SPR, SPG, and SPB of the display region 101 are defined by the black matrix BM. In this case, as illustrated in FIG. 7, the black matrix BM is disposed in the dimming region 102 in the same manner as in the display region 101.

The black matrix BM is disposed in the dimming region 102 in the same manner as in the display region 101. Due to this, it is possible to prevent the user from visually recognizing the dimming region 102 due to the pattern of the black matrix BM being present in the dimming region 102 as well.

### Embodiment 5

In the following, a liquid crystal display device according to Embodiment 5 is described. In the embodiments described above, the dimming filter provided in the dimming region 102 is the same among the pixels PX2. However, in the present embodiment, each pixel PX2 provided in the dimming region 102 includes a dimming filter having a different combination of subfilters. The features common with the embodiments described above are denoted with the same reference numerals, and detailed descriptions thereof are forgone.

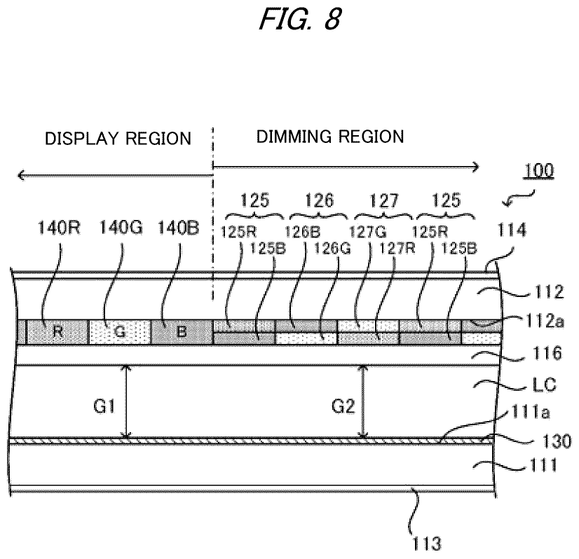

As illustrated in FIG. 8, any of a dimming filter 125 including a combination of a red subfilter 125R and a blue subfilter 125B, a dimming filter 126 including a combination of a blue subfilter 126B and a green subfilter 126G, and a dimming filter 127 including a combination of a green subfilter 127G and a red subfilter 127R is provided in the pixel PX2.

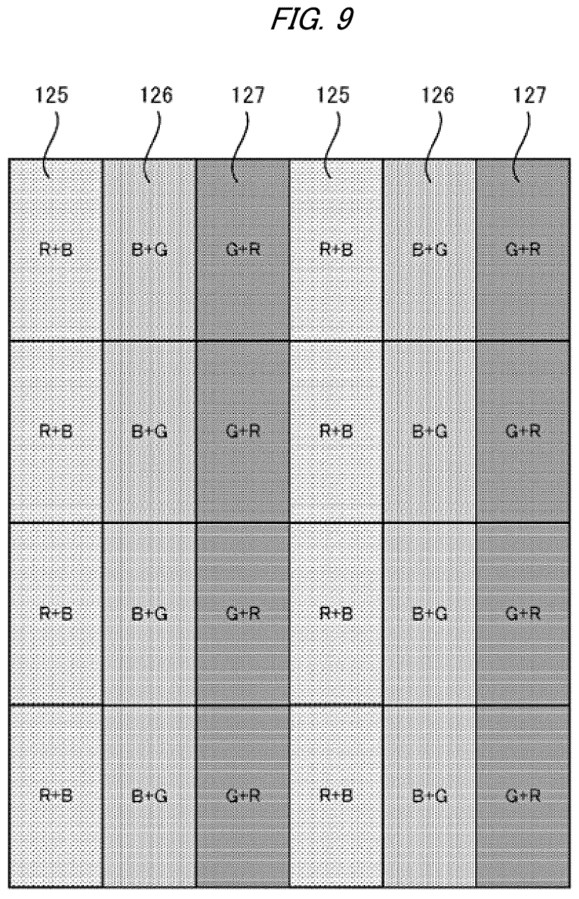

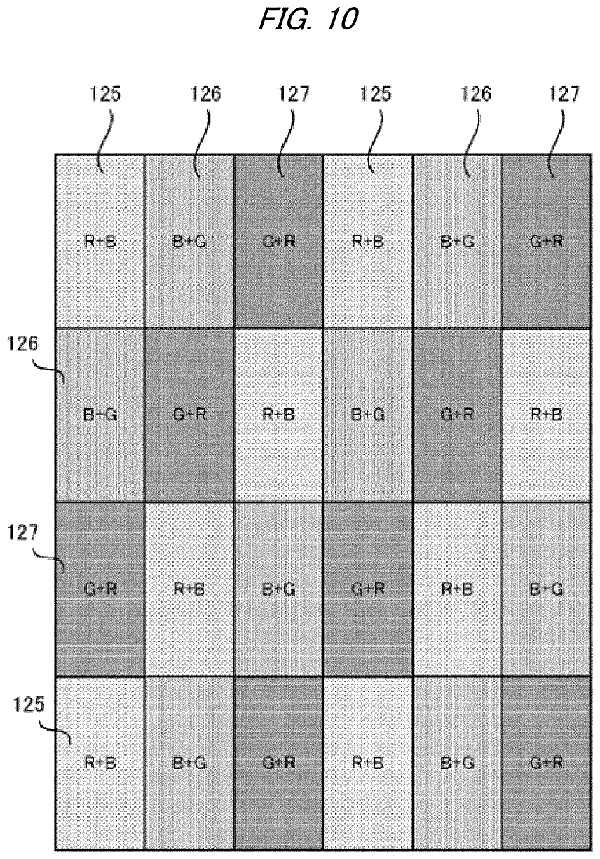

In one example, as illustrated in FIG. 9, the dimming filters 125 to 127 are disposed juxtaposed in stripes. Note that the present disclosure is not limited to the configuration of disposing in stripes, and a configuration is possible in which, as illustrated in FIG. 10, the dimming filters 125 to 127 are disposed in a matrix.

In the liquid crystal display panel of the present embodiment, the dimming filter 125 having the combination of the red subfilter 125R and the blue subfilter 125B, the dimming filter 126 having the combination of the blue subfilter 126B and the green subfilter 126G, and the dimming filter 127 having the combination of the green subfilter 127G and the red subfilter 127R are disposed. Due to this, color difference between the black color tones of the dimming region 102 and the display region 101 can be reduced. Accordingly, it is possible to prevent the user from visually recognizing the dimming region 102.

### Modified Examples of Embodiment 5

In FIGS. 9 and 10, an example of a configuration is described in which the dimming filters 125 to 127 are disposed in stripes or in a matrix. However, the present disclosure is not limited thereto, and a configuration is possible in which the dimming region 102 is divided into sections including a plurality of pixels PX2, for example, 3×3 sections of pixels PX2, and each section is set to the same color filter; for example, one section is set to the dimming filter 125 having the combination of the red subfilter and the blue subfilter, and an adjacent section is set to the dimming filter 126 having the combination of the blue subfilter and the green subfilter.

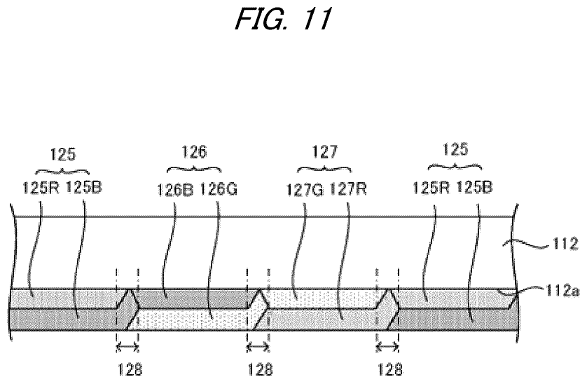

As illustrated in FIG. 11, a configuration is possible in which the dimming filters are formed such that a boundary portion 128, in which the color filter resists of the three colors are stacked, is provided at a boundary where the dimming filter 125 and the dimming filter 126 contact. Note that FIG. 11 illustrates the counter substrate 112 and the dimming filters 125, 126, and 127. As illustrated in FIG. 11, a portion of the subfilter 126G of the dimming filter 126 adjacent to the dimming filter 125 is provided so as to overlap the dimming filter 125. The boundary portion 128 in which the color filter resists of the three colors are stacked is formed by disposing such that the edge of the green subfilter 126G, which the dimming filter 125 does not include, overlaps the dimming filter 125. It is preferable that the boundary portion 128 includes the color filters of the three colors because doing so reduces the color difference with the black of the display region 101. Likewise, it is preferable to form the dimming filters such that the boundary portion 128, in which the color filter resists of the three colors are stacked, is also provided at the boundary where the dimming filter 126 and the dimming filter 127 contact, and the boundary where the dimming filter 127 and the dimming filter 125 contact.

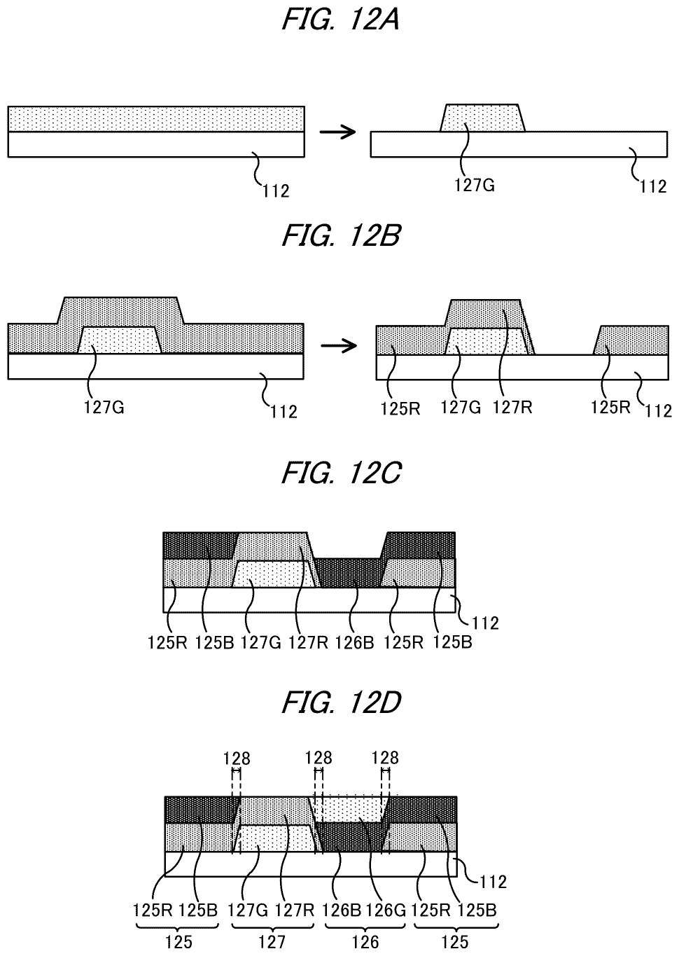

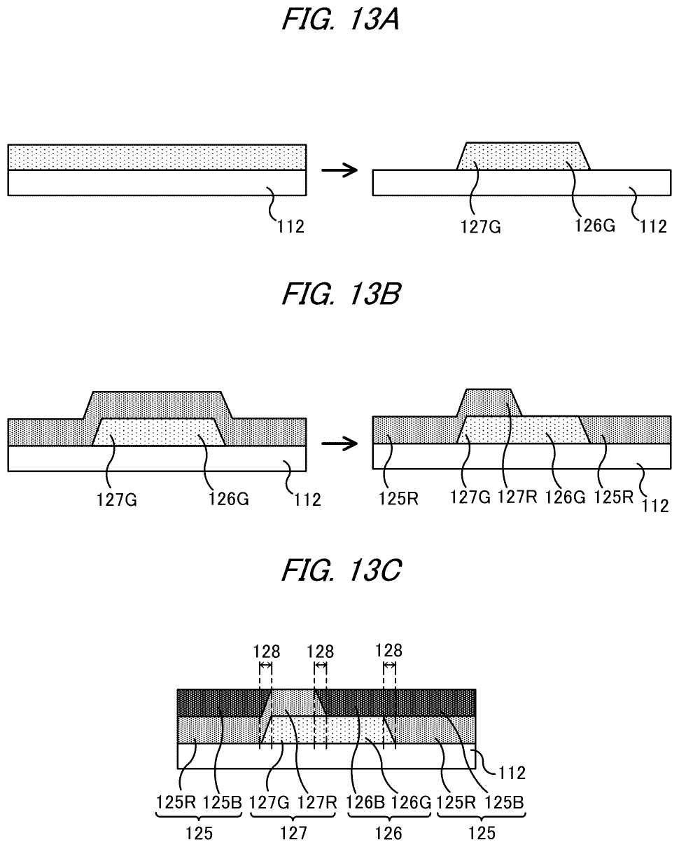

Next, a process of manufacturing the dimming filters 125, 126, and 127 that are formed such that the boundary portion 128, in which the color filter resists of the three colors are stacked, is provided. FIGS. 12A to 12D illustrate an example of manufacturing the dimming filters 125, 126, and 127 in four steps, and FIGS. 13A to 13C illustrate an example of manufacturing the dimming filters 125, 126, and 127 in three steps. Here, the dimming filters 125, 126, and 127 are formed by stacking color filter resists on the counter substrate 112. Accordingly, FIGS. 12A to 12D and FIGS. 13A to 13C are vertically inverted with respect to FIG. 11.

FIG. 12A illustrates a first step of forming the green subfilter 127G. Firstly, as illustrated in the drawing on the left, a green color filter resist is applied on the counter substrate 112 to form a layer. Next, as illustrated in the drawing on the right, the portions, of the green color filter resist, other than where the green subfilter 127G is to be formed, are covered with a photomask and exposure treatment in which infrared light is irradiated is carried out to cure the green color filter resist. Then, development treatment is carried out to remove the uncured portions. Thus, the green subfilter 127G is formed. After the first step is completed, a second step is carried out.

FIG. 12B illustrates a second step of forming the red subfilters 125R and 127R. As illustrated on the left in FIG. 12B, a red color filter resist is formed on the counter substrate 112 on which the green subfilter 127G is formed. As a result, a layer of the red color filter resist for forming the red subfilter 125R is formed on the counter substrate 112, and a layer of the red color filter resist for forming the red subfilter 127R is formed on the green subfilter 127G. Next, as illustrated in the drawing on the right, the portions, of the red color filter resist, other than where the red subfilters 125R and 127R are to be formed, are covered with a photomask and exposure treatment is carried out. Then, development treatment is carried out. Thus, the red subfilters 125R and 127R are formed. After the second step is completed, a third step is carried out.

FIG. 12C illustrates a third step of forming the blue subfilters 125B and 126B. Firstly, a blue color filter resist is applied to a recess on the red subfilter 125R formed on the red color filter resist layer, and to a recess formed on the counter substrate 112. As a result, layers of the blue color filter resist for forming the blue subfilters 125B and 126B are formed. Next, the portions, of the blue color filter resist, where the blue subfilters 125B, 126B are to be formed are exposed, and then development treatment is carried out. Thus, the blue subfilters 125B and 126B are formed. After the third step is completed, a fourth step is carried out.

FIG. 12D illustrates a fourth step of forming the green subfilter 126G. Firstly, a green color filter resist is applied to a recess on the blue subfilter 126B formed on the surface of the color filter resist layer. As a result, a layer of the green color filter resist for forming the green subfilter 126G is formed. Next, the portion of the green color filter resist is exposed, and then development treatment is carried out. Thus, the green subfilter 126G is formed. The dimming filters 125, 126, and 127 are manufactured by carrying out the four steps described above. Here, the boundary portion 128, in which the color filter resists of the three colors are stacked, is formed by the ends of the dimming filters 125 and 127 at the boundary between the dimming filter 125 and the dimming filter 127. Additionally, the boundary portion 128, in which the color filter resists of the three colors are stacked, is formed by the ends of the dimming filters 127 and 126 at the boundary between the dimming filter 127 and the dimming filter 126. Furthermore, the boundary portion 128, in which the color filter resists of the three colors are stacked, is formed by the ends of the dimming filters 126 and 125 at the boundary between the dimming filter 126 and the dimming filter 125. With the dimming filters 125, 126, and 127 manufactured by the four steps, a first layer, formed on the counter substrate 112, is formed from the subfilters 125R, 127G, and 126B of the three colors, and a second layer, formed stacked on the first layer, is formed from the subfilters 125B, 127R, and 126G of the three colors. The subfilters 125B, 127R, and 126G are formed on the subfilters 125R, 127G, and 126B of the first layer and, respectively, differ in color from the subfilters 125R, 127G, and 126B of the first layer. In other words, provided that the dimming filter has a structure in which subfilters of three colors are formed on the first layer and subfilters of three colors that respectively differ from those of the first layer are stacked on the second layer, the dimming filter is manufactured by the four steps described above.

Next, an example of manufacturing the dimming filters 125, 126, and 127 in three steps is described while referencing FIGS. 13A to 13C. FIG. 13A illustrates a first step of forming the green subfilters 127G and 126G. Firstly, as illustrated in the drawing on the left, a green color filter resist is applied on the counter substrate 112 to form a layer. Next, as illustrated in the drawing on the right, the portions of the green color filter resist, other than where the green subfilters 127G and 126G are to be formed, are covered with a photomask and exposure treatment in which infrared light is irradiated is carried out to cure the green color filter resist. Then, development treatment is carried out to remove the uncured portions. Thus, the green subfilters 127G and 126G are formed. Here, the green subfilters 127G and 126G are formed adjacent to each other. The left half of the green color filter resist, formed in a trapezoidal shape by the development treatment, is defined as the green subfilter 127G, and the right half is defined as the green subfilter 126G. Accordingly, the stacking order differs from that of the dimming filter 126 illustrated in FIG. 12D and manufactured by the four steps described above. After the first step is completed, a second step is carried out.

FIG. 13B illustrates a second step of forming the red subfilters 125R and 127R. As illustrated on the left in FIG. 13B, a red color filter resist is formed on the counter substrate 112 on which the green subfilters 127G and 126G are formed. As a result, a layer of the red color filter resist for forming the red subfilter 125R is formed on the counter substrate 112, and a layer of the red color filter resist for forming the red subfilter 127R is formed on the green subfilters 127G and 126G. Next, as illustrated in the drawing on the right, the portions of the red color filter resists, other than where the red subfilters 125R and 127R are to be formed, are covered with a photomask and exposure treatment is carried out. Then, development treatment is carried out. Thus, the red subfilters 125R and 127R are formed. After the second step is completed, a third step is carried out.

FIG. 13C illustrates a third step of forming the blue subfilters 125B and 126B. Firstly, a blue color filter resist is applied to a recess on the red subfilter 125R formed on the red color filter resist layer, and to a recess formed on the green subfilter 126G. As a result, layers of the blue color filter resist for forming the blue subfilters 125B and 126B are formed. Next, the portions, of the blue color filter resist, where the blue subfilters 125B, 126B are to be formed are exposed, and then development treatment is carried out. Thus, the blue subfilters 125B and 126B are formed. The dimming filters 125, 126, and 127 are manufactured by carrying out the three steps described above. Note that, as described above, the stacking order of the dimming filter 126 is the opposite of that in FIG. 12D, and the green subfilter 126G and the blue subfilter 126B are stacked in order on the counter substrate 112. The boundary portion 128, in which the color filter resists of the three colors are stacked, is formed by the ends of the dimming filters 125 and 127 at the boundary between the dimming filter 125 and the dimming filter 127. Additionally, the boundary portion 128, in which the color filter resists of the three colors are stacked, is formed by the ends of the dimming filters 127 and 126 at the boundary between the dimming filter 127 and the dimming filter 126. Furthermore, the boundary portion 128, in which the color filter resists of the three colors are stacked, is formed by the ends of the dimming filters 126 and 125 at the boundary between the dimming filter 126 and the dimming filter 125. With the manufacturing method of FIGS. 12A to 12D, four steps are required, namely, a step of forming the green color filter resist on the counter substrate 112, a step of forming the red color filter resist, a step of forming the blue color filter resist, and a step of further forming the green color filter resist. In contrast, with the manufacturing method of FIGS. 13A to 13C, the step of forming the second green color filter resist can be omitted and the manufacturing can be simplified. With the dimming filters 125, 126, and 127 manufactured by the three steps, a first layer, formed on the counter substrate 112, is formed from the subfilters 125R, 127G, and 126G of two colors, and a second layer, formed stacked on the first layer, is formed from the subfilters 125B, 127R, and 126B of two colors. The subfilters 125B, 127R, and 126B are formed on the subfilters 125R, 127G, and 126G of the first layer and, respectively, differ in color from the subfilters 125R, 127G, and 126G of the first layer. In other words, provided that the dimming filter has a structure in which subfilters of two colors are formed on the first layer and subfilters of two colors that respectively differ from those of the first layer are formed stacked on the second layer, the dimming filter is manufactured by the three steps described above.

### Embodiment 6

In the following, a liquid crystal display device according to Embodiment 6 is described. The present embodiment differs from the embodiments described above in that a greater amount of dimming filters having a specific combination of subfilters are arranged. The features common with the embodiments described above are denoted with the same reference numerals, and detailed descriptions thereof are forgone.

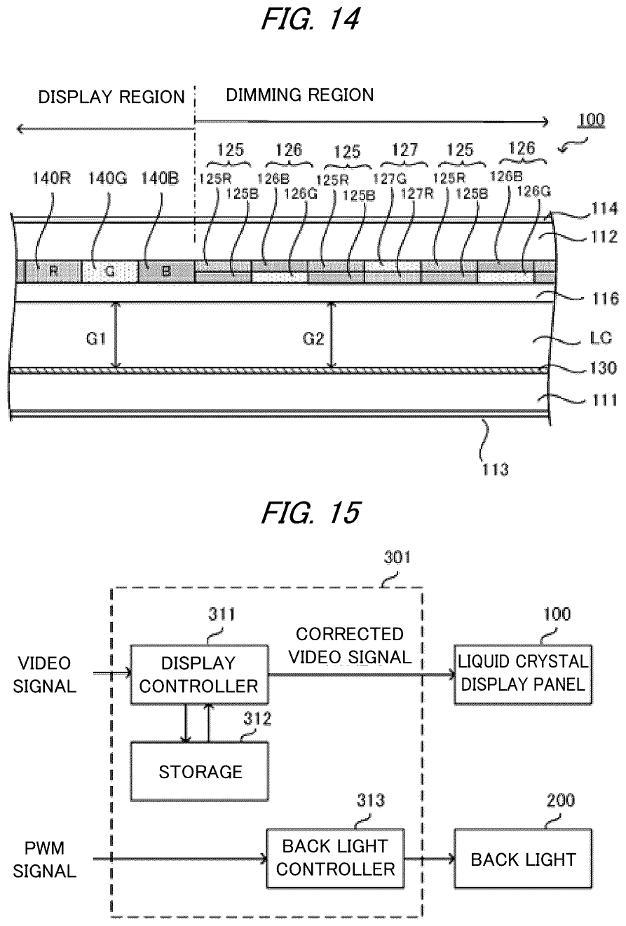

In the dimming region 102 of the present embodiment, as illustrated in FIG. 14, the dimming filter 125 having the combination of the red subfilter 125R and the blue subfilter 125B, the dimming filter 126 having the combination of the blue subfilter 126B and the green subfilter 126G, and the dimming filter 127 having the combination of the green subfilter 127G and the red subfilter 127R are each provided for every pixel PX2.

In the present embodiment, from the left in FIG. 14, the dimming filter 126 is disposed after the dimming filter 125. The dimming filter 125, which has the combination of the red subfilter 125R and the blue subfilter 125B, is disposed again after the dimming filter 126. Next, the dimming filter 127, which has the combination of the green subfilter 127G and the red subfilter 127R, is disposed. Accordingly, a greater number of the dimming filter 125, which has the combination of the red subfilter 125R and the blue subfilter 125B, is disposed. As a result, the color tones of R+B can be intensified.

In this case, as in Embodiment 5, the dimming filters 125 to 127 may be arranged in stripes, or may be arranged in a matrix. The dimming filters 125 to 127 may also be disposed randomly.

Thus, by increasing the number disposed of a dimming filter that includes a specific combination, the color tone of the reflected light and the transmitted light of the dimming region 102 can be changed. By changing the color tone in accordance with the use of the liquid crystal display device 10, it is possible prevent the user from visually recognizing the dimming region 102.

### Embodiment 7

In the following, a liquid crystal display device according to Embodiment 7 is described. The present embodiment differs from the embodiments described above in that the driving voltage applied to the pixel PX2 in the dimming region 102 is varied in accordance with a luminance distribution of the back light 200. The features common with the embodiments described above are denoted with the same reference numerals, and detailed descriptions thereof are forgone.

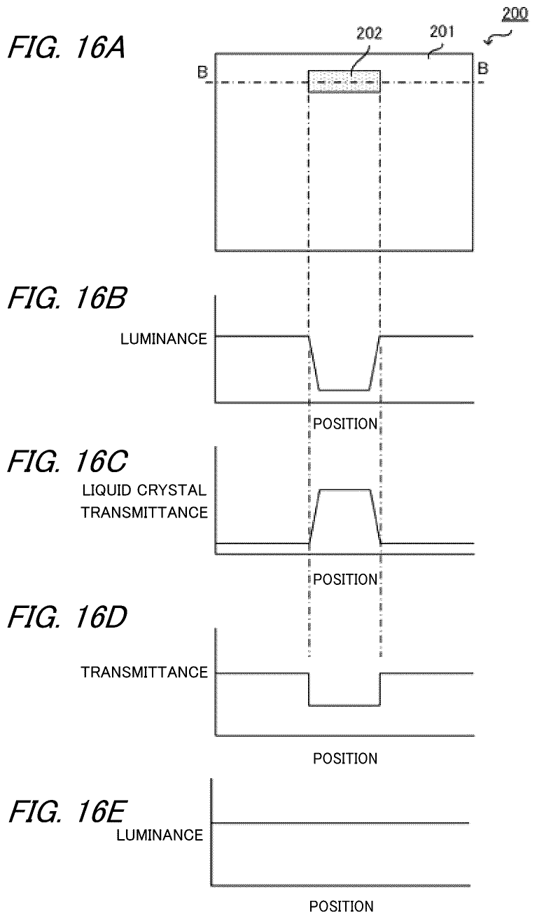

Firstly, FIG. 16A illustrates a top view of the back light. FIG. 16B illustrates a luminance distribution of the back light 200 along line B-B of FIG. 16A. FIG. 16C is a drawing illustrating the transmittance of the liquid crystal layer at a position corresponding to the line B-B of FIG. 16A. FIG. 16D is a drawing illustrating the transmittance of the color filter of the display region 101 and the dimming filter 120 of the dimming region 102, at the position corresponding to the line B-B; and FIG. 16E illustrates the luminance of the liquid crystal display device 10 at the position corresponding to the line B-B.

As illustrated in FIG. 16B, there is a position-based inconsistency in the luminance of the back light 200. Specifically, the luminance gradually decreases toward the periphery center of the imaging region 202. So as to address the slope of the decline in luminance, as illustrated in

FIG. 16C, in the dimming region 102 corresponding to the imaging region 202, the driving voltage of the pixel PX2 is changed in accordance with the luminance distribution such that the transmittance of the liquid crystal layer gradually increases. As a result, the transmittance of the liquid crystal layer LC of the dimming region 102 is corrected.

Specifically, as illustrated in FIG. 15, a controller 301 of the present embodiment includes a display controller 311, a storage 312, and a back light controller 313.

The storage 312 of the controller 301 stores, as a lookup table, correction values of the voltage to be applied to each pixel PX2. The correction values are created on the basis of the luminance distribution in the imaging region 202, which is measured in advance. An example of the luminance distribution is illustrated in FIG. 16B. The display controller 311 generates an inputted video signal, the lookup table stored in the storage 312, and a corrected video signal. Next, the display controller 311 supplies the corrected video signal to the driver IC of the liquid crystal display panel 100. The back light controller 313 sends, to the lighting circuit of the back light 200 and on the basis of a pulse width modulation (PWM) signal, a current value signal expressing a current value to be applied to the light source.

Although there is a position-based inconsistency in the luminance of the back light 200 as illustrated in FIG. 16B, the transmittance of the liquid crystal layer LC of the dimming region 102 is corrected by changing the driving voltage of the pixel PX2 in accordance with the luminance distribution as illustrated in FIG. 16C. As illustrated in FIG. 16D, the transmittance within the dimming region 102 is substantially constant. In the display region 101, the luminance is high as illustrated in FIG. 16B, but the transmittance of the liquid crystal is low as illustrated in FIG. 16C. Additionally, the transmittance of the color filter is high compared to that of the dimming filter. Combining these features, it is possible to make the luminance uniform within the plane, as illustrated in FIG. 16E.

Thus, according to the present embodiment, by changing the voltage applied to the pixel PX2 in accordance with the luminance distribution, luminance inconsistencies in the dimming region 102 can be suppressed and the user can be further prevented from visually recognizing the dimming region.

Embodiments according to the present disclosure are described above, but the present disclosure is not limited to these embodiments. It would be obvious to a person skilled in the art various changes, modifications, combinations, and the like are possible.

Additionally, the various embodiments can be combined. For example, a configuration is possible in which the controller described in Embodiment 7 is combined with the configurations of Embodiments 1 to 6. Moreover, a configuration is possible in which the feature of including a black matrix described in Embodiment 4 is combined with the configuration of Embodiment 2 or 3. Moreover, the number of combinations can be set as desired, and a configuration is possible in which Embodiment 2 and the black matrix described in Embodiment 4 are combined and, in addition thereto, the feature of the controller described in Embodiment 7 is combined.

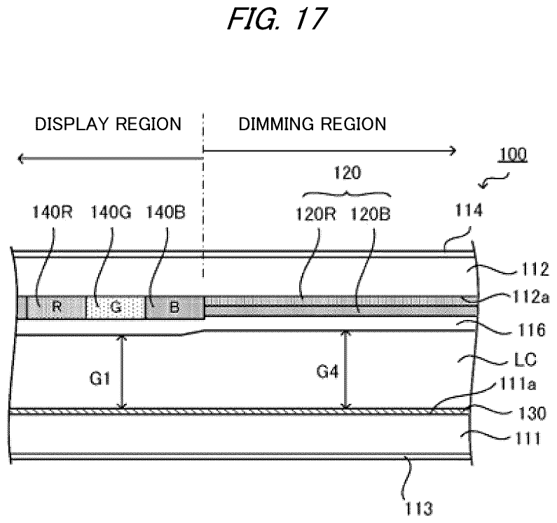

In the embodiments described above, examples of configurations are described in which the cell gap of the dimming region 102 is the same as or narrower than the cell gap G1 of the display region 101, but the present disclosure is not limited thereto. For example, a configuration is possible in which, as illustrated in FIG. 17, the thickness of the dimming filter 120 of Embodiment 1 is formed thinner than that of the color filters 140R, 140G, and 140B. Due to this, the cell gap of the dimming region 102 can be formed wider than the cell gap of the display region.

In Embodiment 3, an example of a configuration is described in which the recess 112b is provided on the counter substrate 112, and the cell gaps G1 and G4 are the same. However, the present disclosure is not limited thereto. A configuration is possible in which Embodiments 3 and 2 are combined, and the cell gap of the dimming region 102 is made narrower than the cell gap G1 of the display region 101. Conversely, a configuration is possible in which, while ensuring the thickness of the dimming filter 123, the cell gap of the dimming region 102 is made larger than the cell gap G1 of the display region 101.

In the embodiments described above, an example is described of a case in which the back light is implemented as an edge-lit back light, but the present disclosure is not limited thereto. For example, a configuration is possible in which the back light is implemented as a local dimming back light.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A liquid crystal display device comprising:
a liquid crystal display in which a liquid crystal layer is disposed;
an illuminator that illuminates the liquid crystal display from behind and that includes an imaging region in which an imager is provided; and
a controller that controls a luminance of the liquid crystal display, wherein
the liquid crystal display includes a display region, and a dimming region provided so as to, when viewing the liquid crystal display planarly, overlap with the imaging region of the illuminator, a dimming filter being provided in the dimming region, and
the controller is configured to control driving of the liquid crystal layer in the dimming region such that a luminance when the display region is set to zero tone and a luminance of the dimming region match.

2. The liquid crystal display device according to claim 1, wherein the dimming filter transmits light in a visible light region and in a near infrared region.

3. The liquid crystal display device according to claim 1, wherein in the dimming filer, at least two color filters among red, green, and blue color filters are stacked, and an OD value of the dimming region in which the dimming filter is provided is from 1.49 to 3.10.

4. The liquid crystal display device according to claim 3, wherein a thickness of the dimming filter is identical to a thickness of a color filter provided in the display region.

5. The liquid crystal display device according to claim 3, wherein a thickness of the dimming filter is greater than a thickness of a color filter provided in the display region.

6. The liquid crystal display device according to claim 1, wherein a cell gap of the liquid crystal layer of the dimming region is narrower than a cell gap of the liquid crystal layer of the display region.

7. The liquid crystal display device according to claim 1, wherein a cell gap of the liquid crystal layer of the dimming region is identical to a cell gap of the liquid crystal layer of the display region.

8. The liquid crystal display device according to claim 1, wherein
the dimming filter is provided on a substrate, and
a thickness of the substrate of the region in which the dimming filter is provided is thin compared to a thickness of the region in which the display region is formed.

9. The liquid crystal display device according to claim 1, wherein
the dimming region is divided by pluralities of pixels,
in the dimming filter, two color filters among red, green, and blue color filters are stacked,
the pixels that are adjacent include dimming filters in which combinations of the two color filters that are stacked on each other differ, and
a boundary portion, in which three color filters, namely a red, a green, and a blue color filter are stacked, is provided at a boundary between the adjacent dimming filters.

10. The liquid crystal display device according to claim 9, wherein in a plurality of the dimming filter arranged in the dimming region, a first layer is formed by three color filters, namely the red, the green, and the blue color filters, and a second layer is formed by three color filters, namely the red, the green, and the blue color filters.

11. The liquid crystal display device according to claim 9, wherein in a plurality of the dimming filter arranged in the dimming region, a first layer is formed by the two color filters among the red, the green, and the blue color filters, and a second layer is formed by two color filters among the red, the green, and the blue color filters.
